(19) United States
(12) Patent Application Publication
(10) Pub. No.: US 2011/0095085 A1
(43) Pub. Date: Apr. 28, 2011

(54) DEBIT CREDIT CARD HOLDER WITH PROCESSOR AND REMINDER TO MAINTAIN A RUNNING BALANCE AT A POINT OF SALE

(76) Inventor: Dorothy Jean Hilliard, Belfair, WA (US)

(21) Appl. No.: 12/911,903

(22) Filed: Oct. 26, 2010

Related U.S. Application Data
(60) Provisional application No. 61/254,867, filed on Oct. 26, 2009.

(51) Int. Cl. G06Q 40/00

(52) U.S. Cl. 235/379

(57) ABSTRACT

A card holder/processor provides convenient place to store debit/credit cards where a user may have immediate access to the existing balance, can deduct expenditures, add deposits and update and save the balance for any of a plurality of accounts. The present invention may remind the user if a transaction has not been recorded and thereby actively assist in keeping an up to date balance. A money clip may be provided to carry paper currency secured to the card holder/processor. The processor may be programmed with various reminders. For example, for a debit card account, the reminder may be set to alert the user if the transaction has caused their account balance to go below a predetermined minimum. Through these settings, the user may prevent bank charges for having an account below the bank's minimum balance. The present invention, unlike other products, may collect all of the usual elements needed for a purchase into one small device. The user is not required to carry and fumble with a wallet, a calculator, a money clip and an account register.

### CROSS-REFERENCE TO RELATED APPLICATIONS

This application claims the benefit of priority to U.S. Provisional patent application No. 61/254,867, filed Oct. 26, 2009, which is herein incorporated by reference.

### BACKGROUND OF THE INVENTION

The present invention relates to personal banking tools and, more particularly, to a holder for keeping a debit and/or credit card, the holder including a processor for maintaining a running balance at the point of sale and a reminder to alert users of certain conditions.

In the past, checks were commonly used to purchase goods and services and a portable checkbook register and/or a carbon copy of the check was provided to keep track of transactions and the resulting balance. Now, the debit/credit card has replaced the checkbook for the vast majority of purchases. The use of such cards has provided a quick and easy way to spend without an equally quick and easy way to check and maintain a running balance. This shortfall has resulted in over 48 billion dollars a year in overdraft fees charged to consumers.

As can be seen, there is a need for an apparatus for permitting consumers to keep a running account balance with them to avoid charges.

### SUMMARY OF THE INVENTION

In one aspect of the present invention, a card holder/processor comprises a main body; a cover attached to the main body, the cover adapted to cover one side of the main body, the cover further adapted to hold one or more cards; a keyboard on the main body, the keyboard adapted to permit a user to enter data; and a processor in the main body for tracking and storing data associated with one or more accounts.

In another aspect of the present invention, a card holder/processor comprises a main body; a cover attached to the main body, the cover adapted to cover one side of the main body, the cover further adapted to hold one or more cards; a keyboard on the main body, the keyboard adapted to permit a user to enter data; a processor in the main body for tracking and storing data associated with one or more accounts; and an alarm for alerting a user when the card holder/processor is opened and data is not entered into the processor.

These and other features, aspects and advantages of the present invention will become better understood with reference to the following drawings, description and claims.

### BRIEF DESCRIPTION OF THE DRAWINGS

FIG. 1 is a front view of the card holder/processor according to an exemplary embodiment of the present invention;

FIG. 2 is a rear view of the card holder/processor of FIG. 1; and

FIG. 3 is a flow chart describing an embodiment for the operation of the card holder/processor of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a convenient place to store debit/credit cards which includes a microprocessor where a user may have immediate access to the existing balance, can deduct expenditures, add deposits and update and save the balance for any of a plurality of accounts. In some embodiments, the present invention may remind the user if a transaction has not been recorded and thereby actively assist in keeping an up to date balance. Embodiments of the present invention may provide a money clip to carry paper currency. The processor may be programmed with various reminders. For example, for a debit card account, the reminder may be set to alert the user if the transaction has caused their account balance to come close (the closeness definable by the user) or go below a predetermined minimum. Through these settings, the user may prevent bank charges for having an account below the bank's minimum balance. The present invention, unlike other products, may collect all of the usual elements needed for a purchase into one small device. The user is not required to carry and fumble with a wallet, a calculator, a money clip and an account register.

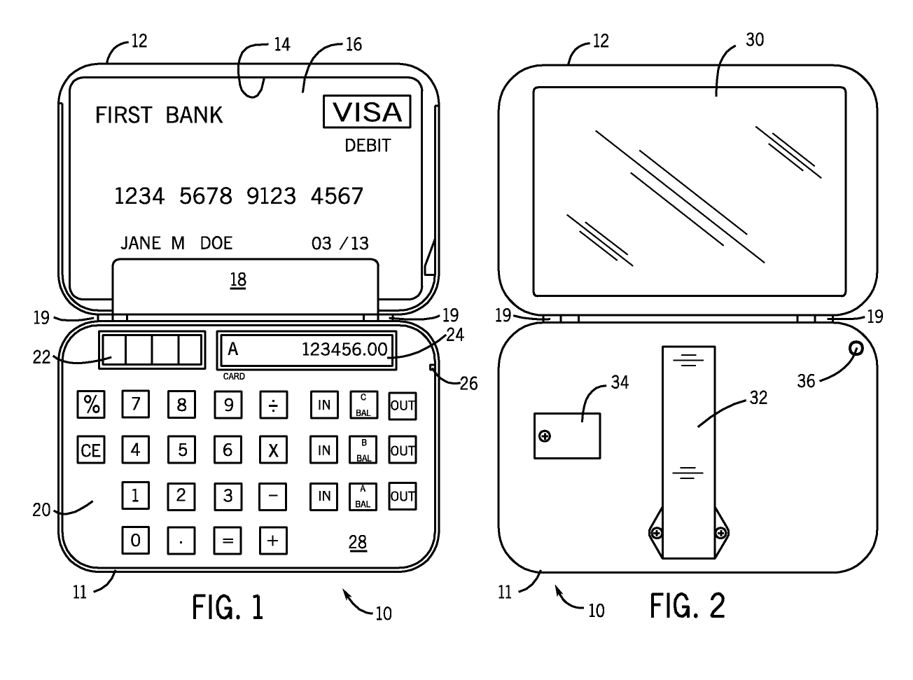

Referring to FIGS. 1 and 2, there is shown a card holder/processor 10 according to an exemplary embodiment of the present invention. The card holder/processor 10 may include a main body 11 connected to a cover 12 with at least one hinge 19. The hinge 19 may include a biasing member (not shown), such as a spring) to secure the card holder/processor 10 in an open position (as shown in FIGS. 1 and 2) or a closed position, for example, where the cover 12 covers the keyboard 28 of the main body 11. The keyboard 28 may allow the user to control account data or use the functions of a normal calculator. A card retainer 18 may be disposed on the cover 12 for holding cards 16 in a card containing cavity 14 in the cover 12. The unattached end of the card retainer 18 may be resiliently deformed away from the cover 12 for securing cards 16 in the card containing cavity 14.

A processor unit 20 may be disposed within the main body 11. The processor unit 20 may be adapted to track transactions for plurality of cards, including card balances, deposits, withdrawals, purchases and the like. The processor unit 20 may be programmable to alert a user if an account balance associated with a card drops below a predetermined minimum. For example, if a bank charges a user a service fee if their account balance falls below $1,000, a user may set an alert to alert the user if their account balance falls below $1,500, for example, thereby assisting the user to avoid the bank's service charge. The processor unit 20 may further require a password each time the device is turned on. The processor unit 20 may keep a record of a plurality of transactions on each account, thereby allowing the user to scroll through a number of prior transactions in each account. The processor unit 20 may date stamp each transaction or may allow input through, for example, a graffiti pad where the user could write in a name to be included. This captured data may be uploaded to financial software, such as Quicken® or Microsoft Money®. The processor unit 20 may include memory for storing data.

The main body 11 may include a display 24. The display may show balances, money placed in an account, money moved out of an account, and which account is currently being displayed. In some embodiments, the card holder/processor 10 may track three accounts, account A, account B and account C, wherein the display 24 shows either A, B or C to indicate each account. In some embodiments, account “A” may be set up as a default account.

A solar panel 22 may be disposed in the card holder/processor 10. The solar panel 22 may be incorporated into the main body 11. The solar panel 22 may be used to provide power to the card holder/processor 10. In some embodiments a battery (not shown) may be disposed in a battery compartment 34. The battery may provide power to the card holder/processor 10 when there is insufficient light for the solar panel 22 to provide sufficient power.

The cover 12 may include a window 30. The window 30 may be useful for a user to insert an identification card, such as a driver's license, there within. This may allow the user to show identification without the need to open the card holder/processor 10 and go through their cards.

An on/off switch 26 may be disposed in the main body 11. The on/off switch 26 may be a button for the user to depress or may be automatically activated upon opening the card holder/processor 10. For example, the on/off switch 26 may turn on the device when it is open and may turn off the device when it is closed. The on/off switch 26 may be used to activate a reminder to the user. For example, if the user opens the card holder/processor 10 to retrieve a card 16, and the user closed the card holder/processor 10 without entering a transaction, the user may be reminded to do so by the device. An alert may be generated through a speaker 36 located in the main body 11.

A money clip 32 may be disposed on the main body 11, opposite the keyboard 28. The money clip 32 may provide a convenient location for the user to keep paper currency.

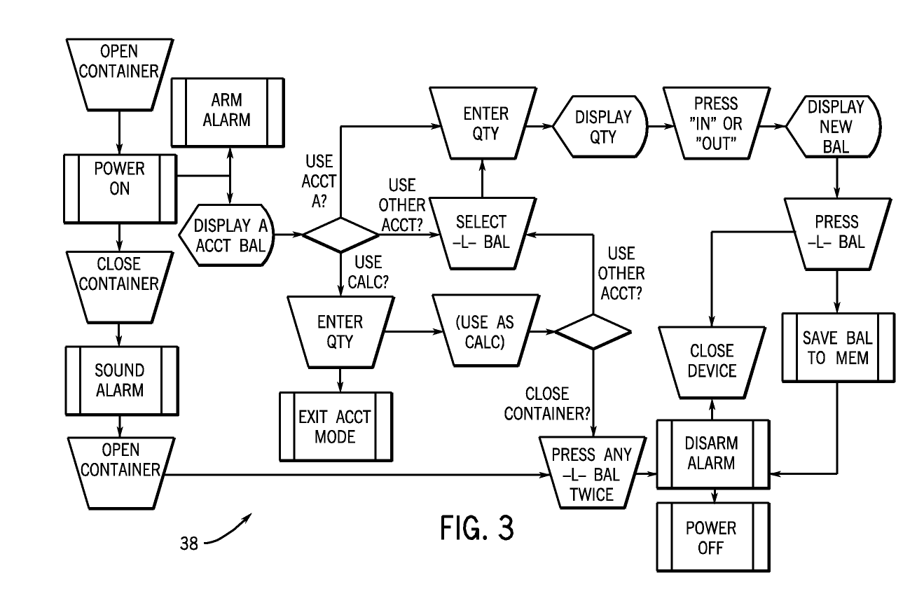

Referring to FIG. 3, a flow chart 38 shows an embodiment of the use of the card holder/processor 10. When the device is opened, the power may automatically turn on. The balance in the default account (account A) may be displayed. If using the device as a calculator, the user may enter numbers similar to a standard calculator. If the user wishes to use Account A, the user may enter a quantity, press IN or OUT and the new balance may be displayed. If the user wishes to use another account, the user may first select that account, enter a quantity, press IN or OUT and the new balance may be displayed. An alarm may sound upon reaching a certain value in the account. This value may be simply a zero balance or a balance programmed by the user. The alarm may be disarmed by a sequence of key presses. When the device is closed, the power may be turned off automatically.

The present invention may be used not only to track balances in various account, but may also be used to track spending. For example, a user may use account C for tracking grocery spending, where the amount of each grocery bill is entered into the device.

It should be understood, of course, that the foregoing relates to exemplary embodiments of the invention and that modifications may be made without departing from the spirit and scope of the invention as set forth in the following claims.

We claim:

1. A card holder/processor comprising:
a main body;
a cover attached to the main body, the cover adapted to cover one side of the main body, the cover further adapted to hold one or more cards;
a keyboard on the main body, the keyboard adapted to permit a user to enter data; and
a processor in the main body for tracking and storing data associated with one or more accounts.

2. The card holder/processor of claim 1, further comprising an alarm for alerting a user when the card holder/processor is opened and data is not entered into the processor.

3. The card holder/processor of claim 1, further comprising a money clip.

4. The card holder/processor of claim 3, wherein the money clip is disposed on the main body opposite the keyboard.

5. The card holder/processor of claim 1, further comprising a card retainer adapted to hold one or more cards in a card containing cavity of the cover.

6. The card holder/processor of claim 1, wherein the processor is powered by at least one of a solar panel and a battery.

7. The card holder/processor of claim 1 further comprising an on/off switch automatically activated when the user opens and closes the card holder/processor.

8. The card holder/processor of claim 1, further comprising a window in the cover, the window adapted to allow a user to view one of the cards held by the cover.

9. A card holder/processor comprising:
a main body;
a cover attached to the main body, the cover adapted to cover one side of the main body, the cover further adapted to hold one or more cards;
a keyboard on the main body, the keyboard adapted to permit a user to enter data;
a processor in the main body for tracking and storing data associated with one or more accounts; and
an alarm for alerting a user when the card holder/processor is opened and data is not entered into the processor.

10. The card holder/processor of claim 9, wherein the processor is programmed to alert the user when the one or more accounts falls below a predetermined minimum.
